(19) United States
(12) Patent Application Publication
(10) Pub. No.: US 2018/0177138 A1
(43) Pub. Date: Jun. 28, 2018

(54) Indoor Gardening System

(71) Applicants: Vineta Adams, Chicago, IL (US); Quentin Adams, Chicago, IL (US)

(72) Inventors: Vineta Adams, Chicago, IL (US); Quentin Adams, Chicago, IL (US)

(21) Appl. No.: 15/855,766

(22) Filed: Dec. 27, 2017

Related U.S. Application Data
(60) Provisional application No. 62/439,270, filed on Dec. 27, 2016.

(51) Int. Cl. A01G 9/02; A47G 7/04; A01G 27/02; A01G 7/04

(52) U.S. Cl. CPC A01G 9/024; A01G 7/045; A01G 27/02; A47G 7/042

(57) ABSTRACT

An indoor gardening system for facilitating easy cultivating of and cooking with fresh herbs and spices is provided. The indoor gardening system comprises a water reservoir for holding a predetermined amount of water with the water reservoir having an outer wall extending from a base wall. A UV lighting system is positioned above the water reservoir. A plurality of plant support arms extend horizontally from the outer wall of the water reservoir with each being substantially perpendicular to the outer wall and fluidly connected to the water reservoir. At least one plant container is supported from at least one plant support arm. Each of the plant support arms is hollow allowing fluid from the water reservoir to move along each plant support arm to be distributed to each of the plants contained in the plant containers.

### CLAIM OF PRIORITY

This patent application claims priority under 35 USC 119 (e) (1) from U.S. Provisional Patent Application Ser. No. 62/439,270 filed Dec. 27, 2016, of common inventorship herewith entitled, “Indoor Gardening System,” which is incorporated herein by reference as though the same were set forth in its entirety.

### FIELD OF THE INVENTION

The present invention pertains to the field of indoor gardening systems, and more specifically to the field of indoor gardening systems for facilitating easy cultivating of and cooking with fresh herbs and spices pike poles.

### BACKGROUND OF THE INVENTION

If one's idea of kicking up a dish is using salt and pepper, there is a rich and fabulously varied world of herbs and spices waiting to be discovered. Mace, coriander, mustard seed, fennel, saffron, basil, mint, rosemary, thyme, and paprika are just a few examples of varied exotic flavorings that do not have to be envisioned as scary untouchables on the supermarket shelf. As many professional and home chefs would agree, cooking with herbs and spices can actually be fun, interesting, enjoyable, and, most of all, delicious. Using herbs and spices vastly improves one's cooking and is extremely effective in allowing cooks to be in full command of their kitchen.

The prior art has put forth several designs for watering systems. Among these are:

U.S. Pat. No. 4,825,591 to Joon H. Han provides a watering device for plants including a plant container balanced on a vertical moving rod by a spring and a water reservoir tank operatively associated with the plant container so that as the plant container becomes lighter due to a loss of water, the spring member disposed at the opposite end of the vertical moving rod from the plant container actuates a valve in the water reservoir tank and transfers water from the water reservoir tank to the plant container until a balance is again achieved, and when the balance is reached, the valve in the water tank is again closed.

U.S. Pat. No. 8,418,403 to Thomas L. Nuttman provides hanging stacked plant holders and watering systems for receiving and supporting a plurality of pots in pot holding rings fastened to the end of a plurality of unit arms. The unit arms are stacked on a structure that includes an upper manifold and a lower manifold. The pots supported by the upper unit arms receive water from the upper manifold, and the pots supported by the lower unit arms receive water seeping through the upper pots, with water seeping through the lower pots being collected for recirculation.

U.S. Pat. No. 8,756,860 to Kevin Murphy provides a plant hanger with a watering system including a weighted base adapted for stable placement on a ground surface and an upwardly-extending support post. A plurality of adjustable hanger arms extends perpendicularly outward from a central hub affixed to the post. A watering system is connected to an existing water source, which delivers water to an inline plant food reservoir for introducing plant food into the water. The water is distributed to each arm through a water distributing manifold attached to an upper end of the post and in fluid communication with the water source.

None of these prior art references describe the present invention.

### SUMMARY OF THE INVENTION

It is an object of the present invention to provide an indoor gardening system for facilitating easy cultivating of and cooking with fresh herbs and spices.

The present invention is an indoor gardening system for facilitating easy cultivating of and cooking with fresh herbs and spices. The indoor gardening system comprises a water reservoir for holding a predetermined amount of water with the water reservoir having an outer wall extending from a base wall. A UV lighting system is positioned above the water reservoir. A plurality of plant support arms extend horizontally from the outer wall of the water reservoir with each being substantially perpendicular to the outer wall and fluidly connected to the water reservoir. At least one plant is supported from at least one plant support arm. Each of the plant support arms is hollow allowing fluid from the water reservoir to move along each plant support arm to be distributed to each of the plants.

In addition, the present invention includes a method for facilitating easy cultivating of and cooking with fresh herbs and spices. The method comprises providing a water reservoir, the water reservoir having an outer wall extending from a base wall, filling the water reservoir with a predetermined amount of water, positioning a UV lighting system above the water reservoir, extending a plurality of plant support arms horizontally from the outer wall of the water reservoir, substantially perpendicular to the outer wall, fluidly connecting the plant support arms to the water reservoir, supporting at least one plant form the at least one plant support arm, and allowing fluid from the water reservoir to move along each plant support arm to be distributed to each of the plants.

The present invention further includes an indoor gardening system for facilitating easy cultivating of and cooking with fresh herbs and spices. The indoor gardening system comprises a water reservoir for holding a predetermined amount of water with the water reservoir having an outer wall extending from a base wall. A support rod extends substantially vertically from the outer wall of the water reservoir. A UV lamp is secured to the support rod and positioned over the water reservoir. A plurality of plant support arms extend horizontally from the outer wall of the water reservoir. Each plant support arm has a first end secured through the outer wall of the water reservoir and is fluidly connected to the water within the water reservoir and a fluidly open second end opposite the first end of the plant support arm. At least one plant is supported from at least one plant support arm. Each of the plant support arms is hollow allowing fluid from the water reservoir to enter the first end, move along each plant support arm, and exit the second end, the water distributed to each of the plants.

### BRIEF DESCRIPTION OF THE DRAWINGS

FIG. 1 is a perspective view illustrating an indoor gardening system, constructed in accordance with the present invention.

FIG. 2 is another perspective view illustrating the indoor gardening system, constructed in accordance with the present invention.

FIG. 3 is a perspective view illustrating the indoor gardening system, constructed in accordance with the present invention, with plants hanging from the system.

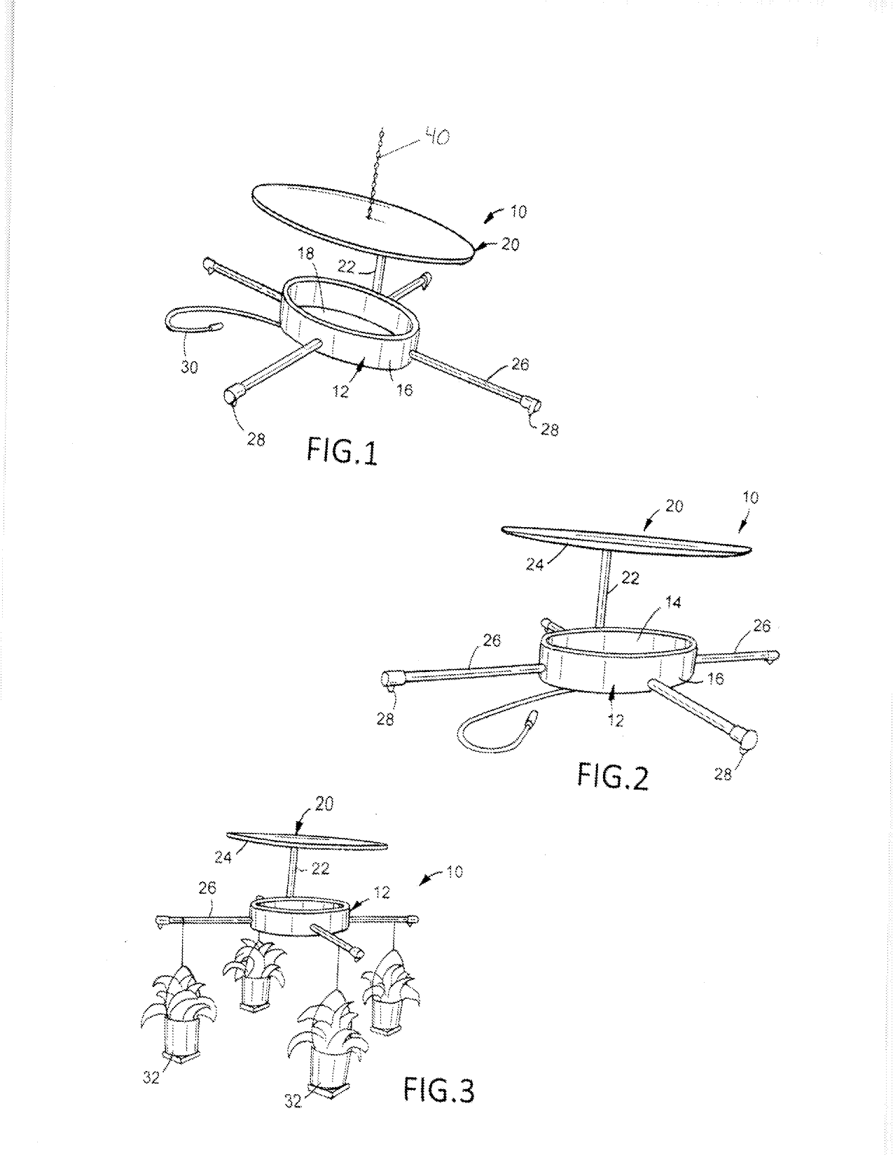

### DETAILED DESCRIPTION OF THE INVENTION

The present invention, hereinafter referred to as an Indoor Gardening System, indicated generally at 10. As the name implies, the Indoor Gardening System 10 is a specially designed for growing food-based condiments right in one's own kitchen.

The Indoor Gardening System 10 of the present invention includes a water reservoir 12 for holding a predetermined amount of water 14. Preferably, the water reservoir 12 has a substantially circular shape. A circular shaped water reservoir 12 allows for easy cleaning with no corners and even distribution of the water 14 from the water reservoir 12. While the water reservoir 12 has been described and illustrated as having a circular shape, constructing the water reservoir 12 in different shapes including, but not limited to, square, rectangular, polygon, etc., is within the scope of the present invention.

In the round embodiment of the water reservoir 12 of the Indoor Gardening System 10 of the present invention, the water reservoir 12 has an outer wall 16 extending from a base wall 18. The outer wall 16 has a top edge. The water reservoir 12 has an open top allowing the user to easily fill the water reservoir 12 with a desired amount of water 14 up to the top edge of the outer wall 16.

In addition, the Indoor Gardening System 10 of the present invention includes a UV lighting system 20 positioned above the water reservoir 12. The UV lighting system 20 has a support rod 22 extending substantially vertically from the outer wall 16 of the water reservoir 12. A UV lamp 24 is secured to the support rod 22 and positioned over the water reservoir 12. In a preferred embodiment, the UV lamp 24 has a substantially circular shape, similar to the water reservoir 12. In this embodiment, the UV lamp 24 preferably has a diameter greater than a diameter of the water reservoir 12 extending the lighting range and grow effectiveness of the UV lamp 24 beyond the extent of the water reservoir 12. The UV lamp 24 provides proper lighting for the Indoor Gardening System 10, as will be described below.

Additionally, the Indoor Gardening System 10 of the present invention includes a plurality of plant support arms 26 extending horizontally from the outer wall 16 of the water reservoir 12, substantially perpendicular to the outer wall 12. Each plant support arm 26 has a first end secured through the outer wall 16 of the water reservoir 12, fluidly connected to the water 14 within the water reservoir 12 and a second end opposite the first end of the plant support arm 26. The second end of the plant support arm 26 has a sprinkler or water outlet 28 allowing water 14 from the water reservoir 12 to exit the plant support arm 26 for distribution to one or more plants contained in plant container 32 suspended from each plant support arm 26. Any number of plants contained in plant containers 32 can be suspended from each plant support arm 26, depending on the desires of the user. Plant containers 32 comprise a flower pot and means for hanging the flower pot from the plant support arm 26.

In a preferred embodiment, the Indoor Gardening System 10 of the present invention has four (4) plant support arms evenly spaced about the water reservoir. By having four (4) plant support arms 26, weight of the Indoor Gardening System is evenly distributed such that the Indoor Gardening System 10 does not tilt and water 14 will be maintained within the water reservoir 12. It should be noted that while the Indoor Gardening System 10 has been described and illustrated as having four (4) plant support arms 26, it is within the scope of the present invention for the Indoor Gardening System 10 to have more than four (4) plant support arms 26 or less than four (4) plant support arms 26.

Furthermore, the Indoor Gardening System 10 of the present invention includes a pull string 30 mounted to the base wall 18 of the water reservoir 12 allowing the user to pull the Indoor Gardening System 10 down to fill the water reservoir 12. A chain 40 extending from the UV lighting system 20 allows the user to hang the Indoor Gardening System 10 from the ceiling or other support. In an embodiment, chain 40 is retractable.

The Indoor Gardening System of the present invention can be constructed in an automated system or a manual unit. The automated system features a selection of components that help ensure care of growing herbs and spices with little effort on the part of the user. The entire assembly of the automated Indoor Gardening System 10 is preferably suspended over the kitchen sink with the UV lighting system 20 providing the plants suspended from the plant support arms 26 with sufficient lighting.

In an embodiment, directly below the UV lighting system 20, the sprinklers 28 can bypass the water reservoir 12, fluidly connecting directly to the sink as a water source to mist the plants in plant containers 32 with water at timed intervals. The plant support arms 26 spread outward and can contain several receptacles for housing the pots containing the herbs and spices the user chooses to grow. Lastly, retractable chain 40 hangs the Indoor Gardening System 10 from the ceiling or other support. Pull string 30 allows the entire assembly to be raised and lowered as needed.

The manual Indoor Gardening System 10 of the present invention contains the same construction as the automated model. The pull string 30 permits the easy raising and lowering of the Indoor Gardening System 10 so that users can add water 14 to the water reservoir 12 when necessary as well as clip the herbs and spices of the plants 32 suspended from the plant support arms 26. As an additional consideration, both models are offered in a variety of colors and material configurations to appeal to individual taste or to match a kitchen's décor.

There are several significant benefits and advantages associated with the Indoor Gardening System 10 of the present invention. Foremost, the Indoor Gardening System 10 provides a user-friendly method of growing fresh herbs and spices. Artfully conceived as an inclusive assembly that can be suspended over a sink or anywhere else in the kitchen (for manual units), the Indoor Gardening System 10 eliminates the clutter that can result from hanging or displaying individual pots when one wishes to grow their own fresh adornments. As a result, users are able to keep their kitchens neat, without plants taking up much needed food preparation space. Allowing home chefs to cook with fresh herbs and spices year-round, the Indoor Gardening System 10 grows virtually any flavoring needed, whether one is preparing antipasto skewers, eggplant caviar, chili con came, or maple apple crisp. While the Indoor Gardening System 10 was primarily conceived with household users in mind, restaurants, bakeries, and catering companies will also certainly appreciate the time- and space-saving benefits of this versatile product line.

The Indoor Gardening System 10 of the present invention readily enhances a plethora of food preparation efforts. Extremely easy to use, the Indoor Gardening System 10 proves especially beneficial to novice cooks while easing the burdens of more seasoned chefs.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An indoor gardening system for facilitating easy cultivating of and cooking with fresh herbs and spices, the indoor gardening system comprising:
a water reservoir for holding a predetermined amount of water, the water reservoir having an outer wall extending from a base wall;
a UV lighting system positioned above the water reservoir;
a plurality of plant support arms extending horizontally from the outer wall of the water reservoir, substantially perpendicular to the outer wall, fluidly connected to the water reservoir; and
at least one plant container supported from at least one plant support arm;
wherein each of the plant support arms is hollow allowing fluid from the water reservoir to move along each plant support arm to be distributed to each of the plant containers.

2. The indoor gardening system of claim 1 wherein the water reservoir has a substantially circular shape.

3. The indoor gardening system of claim 1 wherein the water reservoir has an open top.

4. The indoor gardening system of claim 1 wherein the UV lighting system has a support rod extending substantially vertically from the outer wall of the water reservoir and a UV lamp secured to the support rod and positioned over the water reservoir.

5. The indoor gardening system of claim 4 wherein the UV lamp has a substantially circular shape.

6. The indoor gardening system of claim 4 wherein the UV lamp has an outer extent greater than an outer extent of the water reservoir.

7. The indoor gardening system of claim 1 wherein each plant support arm has a first end secured through the outer wall of the water reservoir, fluidly connected to the water within the water reservoir and a fluidly open second end opposite the first end of the plant support arm.

8. The indoor gardening system of claim 7 and further comprising:
a sprinkler mounted to the second end of each plant support arm.

9. The indoor gardening system of claim 1 and further comprising:
four (4) plant support arms evenly spaced about the water reservoir.

10. The indoor gardening system of claim 1 and further comprising:
a pull string mounted water reservoir.

11. The indoor gardening system of claim 1 and further comprising:
a chain extending from the UV lighting system.

12. A method for facilitating easy cultivating of and cooking with fresh herbs and spices, the method comprising:
providing a water reservoir, the water reservoir having an outer wall extending from a base wall;
filling the water reservoir with a predetermined amount of water;
positioning a UV lighting system above the water reservoir;
extending a plurality of plant support arms horizontally from the outer wall of the water reservoir, substantially perpendicular to the outer wall;
fluidly connecting the plant support arms to the water reservoir;
supporting at least one plant container from the at least one plant support arm; and
allowing fluid from the water reservoir to move along each plant support arm to be distributed to each of the plant containers.

13. An indoor gardening system for facilitating easy cultivating of and cooking with fresh herbs and spices, the indoor gardening system comprising:
a water reservoir for holding a predetermined amount of water, the water reservoir having an outer wall extending from a base wall;
a support rod extending substantially vertically from the outer wall of the water reservoir;
a UV lamp secured to the support rod and positioned over the water reservoir;
a plurality of plant support arms extending horizontally from the outer wall of the water reservoir, each plant support arm having a first end secured through the outer wall of the water reservoir, fluidly connected to the water within the water reservoir and a fluidly open second end opposite the first end of the plant support arm; and
at least one plant container supported from at least one plant support arm;
wherein each of the plant support arms is hollow allowing fluid from the water reservoir to enter the first end, move along each plant support arm, and exit the second end, the water distributed to each of the plant containers.

14. The indoor gardening system of claim 13 wherein the water reservoir has a substantially circular shape.

15. The indoor gardening system of claim 13 wherein the water reservoir has an open top.

16. The indoor gardening system of claim 13 wherein the UV lamp has a substantially circular shape.

17. The indoor gardening system of claim 13 wherein the UV lamp has an outer extent greater than an outer extent of the water reservoir.

18. The indoor gardening system of claim 13 and further comprising:
a sprinkler mounted to the second end of each plant support arm.

19. The indoor gardening system of claim 13 and further comprising:
four (4) plant support arms evenly spaced about the water reservoir.

20. The indoor gardening system of claim 1 and further comprising:
a pull string mounted water reservoir; and
a chain extending from the UV lighting system.
